(19) United States
(12) Patent Application Publication
(10) Pub. No.: US 2004/0066500 A1
(43) Pub. Date: Apr. 8, 2004

(54) Occupancy detection and measurement system and method

(76) Inventors: Salih Burak Gokturk, Mountain View, CA (US); Abbas Rafii, Palo Alto, CA (US)

Correspondence Address: Shemwell Gregory & Courtney LLP, Suite 201, 4880 Stevens Creek Blvd., San Jose, CA, 95129, US

(21) Appl. No.: 10/678,998

(22) Filed: Oct. 2, 2003

Related U.S. Application Data
(60) Provisional application No. 60/415,946, filed on Oct. 2, 2002.

(51) Int. Cl. G01C 3/08

(52) U.S. Cl. 356/4.01

(57) ABSTRACT

Occupancy detection and measurement, and obstacle detection using imaging technology. Embodiments include determining occupancy, or the presence of an object or person in a scene or space. If there is occupancy, the amount of occupancy is measured.

### FIELD OF THE INVENTION

Embodiments of the invention relate to imaging apparatus and methods. In particular, embodiments relate to detection, such as detection of persons or objects, and measurement using imaging technology.

### BACKGROUND OF THE INVENTION

Literature contains various methods for dimensioning objects. Mechanical rulers are available in many stores, and they require contact to the surface that they measure. Optical methods are available for measuring various properties of a scene.

Various patents describe using optical triangulation to measure the distance of objects from a video sensor. For example, in U.S. Pat. No. 5,255,064, multiple images from a video camera are used to apply triangulation to determine the distance of a moving target.

In U.S. Pat. No. 6,359,680, a three-dimensional object measurement process and device are disclosed, including optical image capture, projection of patterns and triangulation calculations. The method is used for diagnosis, therapy and documentation in the field of invasive medicine.

In U.S. Pat. No. 6,211,506, a method and apparatus for optically determining the dimension of part surfaces, such as gear teeth and turbine blades is disclosed. The method uses optical triangulation based coordinate measurement for this purpose.

In U.S. Pat. No. 5,351,126, an optical measurement system for determination of a profile or thickness of an object is described. This system includes multiple light beams generating multiple outputs on the sensor. The outputs are processed in sequence to measure by triangulation the perpendicular distance of the first and second points from the reference plane and to analyze a surface or thickness of the object based upon thus measured perpendicular distances.

The U.S. Pat. No. 6,621,411 is a representative of a series of proposed systems to detect the presence of an occupant in a car compartment like the trunk of a car. Such a system may warn the driver that someone may be trapped in the trunk of a car and may trigger an emergency action.

Stereo vision has been proposed in the literature of computer vision and in several U.S. patents as a method to compute the three-dimensional shape of scenes in the world. Presumably, in a sufficiently lit area, a stereo vision system can be used to obtain a depth map of a scene and then use image processing methods to detect the occupancy of a compartment or obstacles in the way of a robot. But there are a number of well-known inherent problems with stereo vision that are cited in these patents. For example, in the U.S. Pat. No. 5,076,687 it is stated that: “The most popular passive technique, binocular stereo, has a number of disadvantages as well. It requires the use of two cameras that are accurately positioned and calibrated. Analyzing the data involves solving the correspondence problem, which is the problem of determining the matches between corresponding image points in the two views obtained from the two cameras. The correspondence problem is known to be difficult and demanding from a computational standpoint, and existing techniques for solving it often lead to ambiguities of interpretation. The problems can be ameliorated to some extent by the addition of a third camera (i.e. trinocular stereopsis), but many difficulties remain.” The U.S. Pat. No. 6,081,269 also discusses the deficiencies of current stereo techniques: “Another approach is that of constructing depth maps by matching stereo pairs. The problem with this is that depth cannot reliably be determined solely by matching pairs of images as there are many potential matches for each pixel or edge element. Other information, such as support from neighbors and limits on the disparity gradient must be used to restrict the search. Even with these, the results are not very reliable and a significant proportion of the features are incorrectly matched.”

Although methods exist for detecting occupancy, measuring objects remotely and detecting obstacles, what is needed is a cost-effective and practical solution that works under various environmental conditions and requires minimum image processing.

### SUMMARY OF THE INVENTION

Embodiments of the invention include methods for detecting the presence of objects, sensing and measuring occupancy in a space, sensing and measuring changes in occupancy in a space, sensing emptiness, sensing and estimating the full-ness factor in a compartment and detecting obstruction. In one embodiment, the occupancy detection method determines if a space is empty or non-empty. The occupancy measurement further determines how much of the space is empty or non-empty. From a known state of occupancy of a space, the method, in one embodiment, determines any changes to the occupancy of the space. If the space is determined to be partially full, the full-ness factor expresses the percentage of the space that is full.

A space as used herein typically means an enclosed environment such as a room, a factory floor, a compartment, a container, or any other space enclosed by some boundaries such as walls or other demarcations. When mounted on a mobile device such a robot, an embodiment of the invention can be used to detect an obstruction in the path of the robot and also to determine the distance from the obstruction. Without limitation, these methods can be used in a truck trailer, in a container, in a warehouse, for a store shelf, or in any kind of room to determine if the space if full, empty or somewhere in between, or in a security system to detect the presence of an intruder in the room, or to detect if there are any objects in front of a robot or other system.

### BRIEF DESCRIPTION OF THE DRAWINGS

Embodiments of the invention are illustrated by way of example, and not by way of limitation, in the figures of the accompanying drawings. Like reference numerals are intended to refer to similar elements among different figures.

FIG. 1 illustrates the components of a system for an embodiment of the current invention.

FIG. 2a illustrates a method for implementing an occupancy detection system in a room.

FIGS. 2b, 2c and 2d illustrate different embodiments for creating a fan-shaped light source.

FIG. 3a illustrates an example image obtained when there is no occupancy in a scene.

FIG. 3b illustrates an example image obtained when there is occupancy in a scene.

FIG. 4 illustrates the components of an embodiment of an occupant distance measurement setup.

FIG. 5 illustrates an exemplary arrangement of light sources for an occupancy measurement system.

FIG. 6 illustrates an example image of an empty room as obtained by a 3D range sensor.

FIG. 7 illustrates an embodiment of an obstacle detection system on a robot.

FIG. 8 illustrates another embodiment of an obstacle detection system on a robot.

FIG. 9 illustrates an embodiment of an obstacle detection system on a trail.

### DETAILED DESCRIPTION

Embodiments of the invention include a system and methods for detecting the presence of objects, sensing and measuring occupancy in a space, sensing and measuring changes in occupancy in a space, sensing emptiness, sensing and estimating the full-ness factor in a compartment, detecting obstruction, and measuring the amount of occupancy in an enclosed space such a room, a building or a compartment. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid obscuring the invention.

Overview

Embodiments of the invention include methods for detecting occupancy and measuring the amount of occupancy, such as by objects, animals or human forms in a space. The space is typically an enclosed environment such as a room, a compartment, a container, a truck container, a shelf space, the inside of a building, etc. Henceforth, the term “room” is used to refer to all these types of spaces.

The occupancy detection system and methods determines if a room is empty or non-empty. The occupancy detection system and methods include a camera system and an optional structured or unstructured light source illuminating the scene. When a light source is used, it serves two purposes. First, it enables the system to make measurements in absence of ambient light, for instance in a dark enclosure. Second, the light source is a component in performing the measurement.

In one embodiment, to get a reference image for the initial condition of an empty room, a camera sensor captures the image of the room while it is empty. This image is used as a training or reference image. When the camera captures an image of a non-empty room, the image is different from the reference image.

The occupancy measurement methods approximate the amount of empty and full volume in the scene. The occupancy measurements also determine relative distance of objects in the scene from a reference point. In one embodiment, the occupancy is determined using triangulation methods. In another embodiment, three dimensional sensors are used and the occupancy is measured directly from the depth images.

The systems and methods described herein can also be used in applications such as intruder detection in a space, occupancy detection in a room or truck, occupancy measurement in a room or truck, collision avoidance, and obstacle detection.

Terminology

The term “image” as used herein implies an instance of light recorded on a tangible medium. The image does not have to be a recreation of the reflection, but merely record a characteristic such as brightness, particularly from various points of a surface or area in which a reflection is being created. The tangible medium may refer to, for example, an array of light-sensitive pixels.

The term “depth” as used herein implies a distance between a sensor and an object that is being viewed by the sensor. The depth can also be a relative term such as a vertical distance from a fixed point in the scene closest to the camera.

The term “three-dimensional sensor” as used herein refers to a special type of sensor in which each pixel encodes the depth information for the part of the object that maps to the particular pixel. For instance, U.S. Pat. No. 6,323,942, titled “CMOS—compatible three-dimensional image sensor IC” is an example of such a sensor.

The term “occupancy detection” as used herein refers to detecting an object, an animal, or a human being in a scene or a room.

The term “occupancy measurement” as used herein refers to detecting the amount of occupancy by objects, animals or human beings.

The term “full-ness factor” as used herein refers to a ratio of the space that is occupied divided by the actual size of the space when is it empty.

Occupancy Detection System

In order to decide whether room is occupied or not, it is sufficient to determine that it is different from an empty one. A room is therefore empty or non-empty. The methods described herein use imaging techniques to determine whether a room or other space is empty or non-empty.

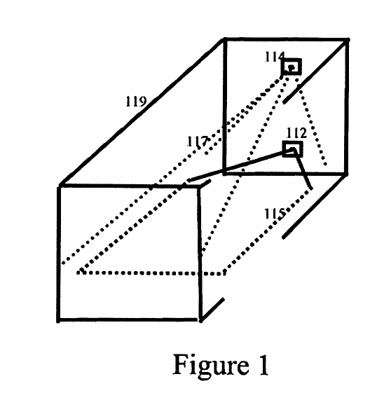

FIG. 1 illustrates an embodiment of an occupancy detection system. The system includes an imaging sensor 114, and structured or unstructured light shown by dashed line 115. The light 115 may also have either a visible or invisible spectrum. In one embodiment, the structured light 115 is fan shaped beam, and cuts the plane 112 in the room 119. First, an image of the empty room is obtained while being lit by the light source 115. The intersection of the light source with the boundaries of the room becomes visible as a bright pattern in the image distinguishable from the unlit background surfaces. This image is called the training or reference image. During the operation, when the system decides if the room 119 is empty or not, the image of the room is obtained and compared with the reference image. If the image is sufficiently similar to the reference image, the system decides that the room is empty. Otherwise, it decides that the room is non-empty.

For the clarity of the presentation, we assume that no object is hanging from the ceiling. If an object is hanging from the ceiling, the system can still be used by raising the light beam or configuring the system, in a reverse mode, such that the sensor is below the light source.

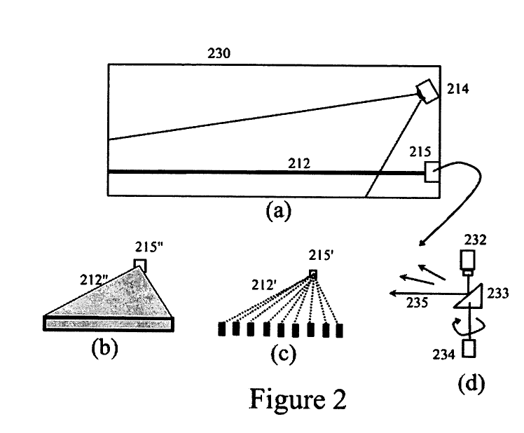

FIG. 2a illustrates an elevation view of the system described in FIG. 1. The system involves an imaging sensor 214, and a light source 215 that produces light 212 that grazes above the surface in the space 230. The light source may be generated in various ways, but should be projected as line and be visible when the sensor collects light. FIG. 2b illustrates an embodiment where the light source is generated by a line generator 215″. In this case, the produced light 212″ would span a complete plane. FIG. 2c illustrates another embodiment that uses a number of point sources, or a shape generator 215′ that produces a number of directional beams defining a planar surface. These beams construct lines on the same plane that produce a light pattern shown in FIG. 2c. The advantages of these light source embodiments are that they do not require a moving part.

FIG. 2d illustrates another embodiment that uses a point source 232 that emits the light beam 235 and a rotating mirror or prism 233 that is rotated by a rotor 234. In one embodiment, the mirror rotates very fast in which case each camera captures the projected line in one frame. In another embodiment, the mirror rotates slowly. In this case, the camera captures many images of the environment and joins them together to capture the resulting projected line pattern. This is equivalent to applying time-multiplexing of the light source. In this case, a delay in integration time is possible. For example, the mirror may make a 360-degree turn in a minute or so. The advantage of this embodiment is that it can be used to scan larger rooms.

In another embodiment, the light source may also be generated by a structured flashlight which is synchronized with the sensor shutter. A camera that is located above the light source captures the image of the room.

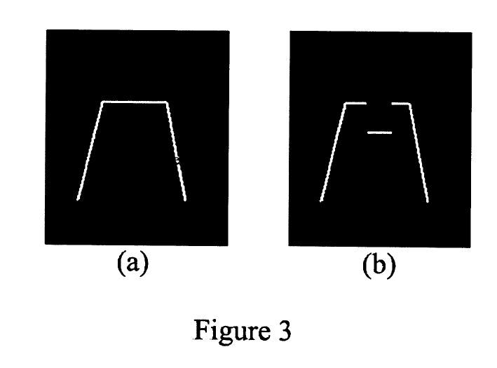

As an example, the projected image of an empty rectangular room would look like the pattern shown in FIG. 3a, and that of a non-empty room would be as in FIG. 3b.

In another embodiment, a flashlight illuminates the scene. The resulting intensity image is first normalized for local intensity variations. Normalized intensity images of the empty and non-empty rooms are then compared.

In situations with difficult ambient light conditions, in another embodiment, reflectors are affixed on the side of the room. The room is lit with a light source. Preferably, the light source should be near the sensor. The reflector has the ability to efficiently reflect even minute amounts of light that it receives. As a consequence, the reflected light would be observed on the image unless the reflector is hidden from the sensor. A training image is obtained when the room is empty. This image contains the reflector. In the operation mode, the image is compared to the training image. If the image is different, there is an occupant object blocking the reflector; therefore, the room is non-empty.

Occupancy Measurement System

The occupancy measurement system determines the occupancy (in volume or area) of the objects in a room. For example, without any limitation, it can be used to determine how much room is still available in a partially loaded truck. The methods described can use any of the previously mentioned structured light patterns and a camera to image their reflections from objects in a room.

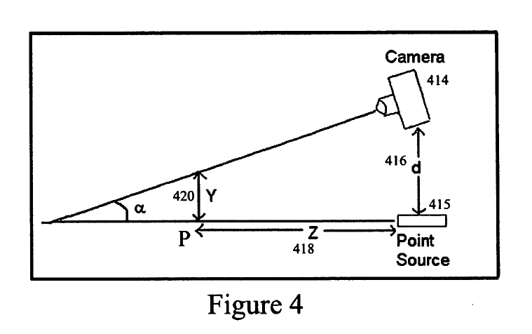

FIG. 4 illustrates the use of a point source 415 and a camera 414 to determine the location of a surface that reflects the light. Let Z 418 be the distance of the reflecting surface from the camera and source. Let d 416 be the separation of the light source from the camera, and let Y 420 be the vertical location of the reflection. Let the 3D world location of the reflection point P be (X, Y, Z). Let α be the angle between the optical axis of the camera and the optical axis of the light source. This is a known value defined by the known relative position and orientation of the light source and the camera. Let ƒ be the focal length of the camera lens. Let (P_{X},P_{Y}) be the coordinates of the projection of point P in the image plane of the camera relative to center of projection of the camera plane. The relation between Y, and its vertical projection P_{Y} on the image plane are given by the following:

$${P}_{Y} = \frac{f}{Z} Y \qquad ( Equation 1 )$$

Similarly given the projection P_{Y}, the depth Z is given as follows:

$$Z = \frac{f}{{P}_{Y}} Y \qquad ( Equation 2 )$$

Given that the geometry of the source and the camera is known, Y is given as follows:

Y=(−Z tan α+d) (Equation 3)

Replacing Y in Equation 2:

$$Z = \frac{\frac{f}{{P}_{Y}} d}{1 + \frac{f}{{P}_{Y}} tan α} \qquad ( Equation 4 )$$

Similarly, X is given in terms of the projection P_{X} and Z as follows:

$$X = \frac{f}{{ZP}_{X}} \qquad ( Equation 5 )$$

Therefore, given that the geometry of the light source and the camera are known, the 3D location (X,Y,Z) of the reflection point P can be calculated from the image projection (P_{X},P_{Y}). Embodiments of methods described herein use this observation, and light the scene by structured light of known geometry. The 3D location (X,Y,Z) of every reflection point is computable. The described methods then use a collection of measurements and approximate the occupied volume and area in the room.

The resolution of the method is somewhat a function of the distance d. The resolution can be defined by the size of the smallest object that can be detected in the furthest part of the room. Within certain practical limits, the higher values of d produce better resolution.

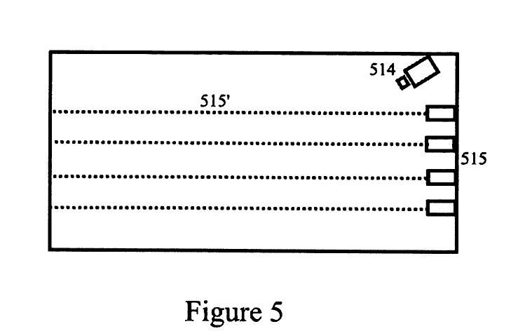

In one embodiment, the structured light system described in FIG. 5 can be used. In this setup, a camera 514 is located on top of a number of parallel light sources 515. Each light source 515′ is fan-shaped. As a result, a series of parallel lines span the room parallel to its surface. Each of these lines can alternatively be obtained using a mirror system as illustrated in FIG. 2d. In another embodiment, one single line can be rotated vertically to obtain multiple lines. Using the equations 1 through 5, the 3D geometry as intersected by the light sources can be calculated. The geometry of objects that lie between the lines can be approximated by averaging between the geometry as intersected by two lines that surround that object. From the geometry of the lines, the volumetric occupancy of the whole scene can be calculated.

In another embodiment, the full-ness of the room can be estimated by making assumptions about the size of the objects in the room. For instance, for a cargo application, the objects are typically boxes and therefore one can estimate their volume assuming that the space behind the boxes is also occupied. Once the full-ness of the room is estimated, the ratio of this number divided by the actual size of the room gives the full-ness factor.

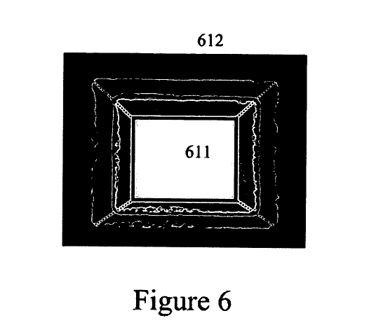

Another embodiment for occupancy measurement involves the direct use of three-dimensional sensors. A three-dimensional sensor gives a depth image of the scene. There are various three-dimensional sensing techniques in the literature. Time of flight, active triangulation, stereovision, depth from de-focus, structured illumination and depth from motion are some of the known three-dimensional sensing techniques. These sensors provide a depth image of the scene, which gives the depth of each pixel from the sensor. These depth values can further be used to calculate the occupied volume and area in the room. In one embodiment of such a system, a depth sensor is located in one end of the room. Additional lighting might still be necessary if the room is too dark for the sensor to operate. An example of a resulting depth map of an empty room is shown in FIG. 6. In FIG. 6, the light gray area 611 denotes greater distance from the sensor, and dark gray are 612 denotes less distance from the sensor. This depth map is used as a training image to calculate the volume of the empty room.

During the operation, the depth image of the scene is obtained using the sensor. Using the depth (Z) values, the 3D coordinate (X,Y,Z) of every visible point in the scene can be calculated using equations 2 and 5. Assuming that the room is full behind each visible point, the occupancy can be calculated using these three-dimensional coordinates and the training depth map of the empty room.

Obstacle Detection System

The obstacle detection combines the methods for occupancy detection and occupancy measurement. The occupancy detection determines the presence of an object. The occupancy measurement determines the distance to the object. For instance, a robot equipped with an embodiment of this invention may evade an obstacle or completely stop when it gets too close to an obstacle.

Other Applications

Embodiments of the invention are useful for detecting obstacles, without any limitation, in front of a robot roaming around a room, on the path of a train as it runs on its track, or in front of a car to detect the curb while parking or to detect if the car is too close to the car in front in a highway.

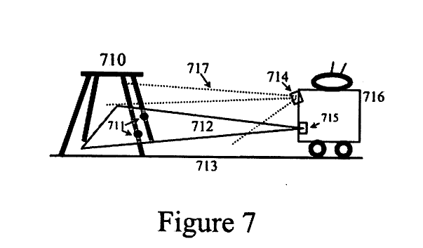

As shown in FIG. 7, the robot 716 is equipped by a fan-shaped light source 715 and a camera sensor 714 with a field of view 717. As the robot 716 moves on the surface 713, the sensor collects the images of the light hitting obstacles 711. The reflection would appear in the camera if there was an obstacle 710 in front of the robot 716. The robot 716 includes a processor (not shown) that uses the triangulation methods described above to detect the distance of the obstacles, and avoid colliding with them.

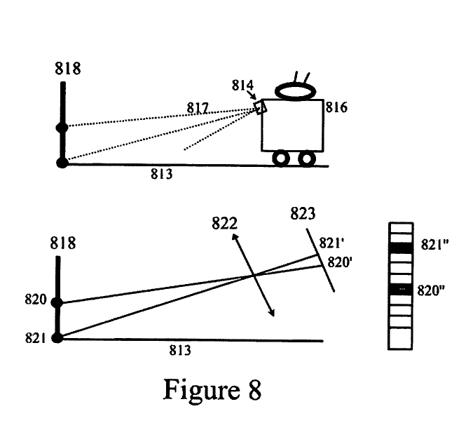

In another embodiment, as illustrated by FIG. 8, no structured light source is used by the robot 816. It uses a camera sensor 814 with a lens 822, and grabs an image through its field of view 817. It uses the location of the ground 813 as if it is a light source. In the projection image 823, the point where an object 818 intersects the ground 813 is given by the point 821. This point projects to the pixel 821′ in the image plane. This point can be located in the image plane using conventional edge processing. Once the vertical distance of the ground 813 and the camera 814 are known, the distance of point 821 from the robot 816 can be calculated using triangulation techniques (including Equations 2-5). Furthermore, the height of any point 820 that is in the same surface 818 with point 821 can be calculated. Using these measures, the robot 816 or any other system that carries this vision system can detect the obstacles.

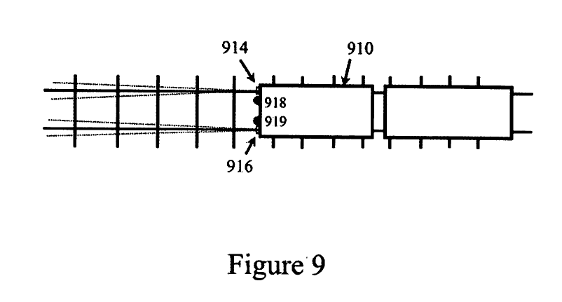

FIG. 9 shows another application of the system used for detecting obstacles on a track. A lead car 910 is equipped with a pair of light sources 914 and 916 and camera sensors 918 and 919 above each track. The light generated by the light sources 914 and 916 will hover above the track at a height appropriate to the smallest object that needs to be detected. The training image will be devoid of any reflected light. However, when an obstacle appears on the track, an image will appear on the sensor. The distance of the object from the car 910 can be determined by the location of the line on the sensor using the same methods described with reference to occupancy measurement.

In another application of the system, the obstacles in front or at the back of a car are detected. The front of the car is equipped by a system consisting of a fan light source and a camera, or by a system consisting of a single 3D camera sensor. The distance of the closest object can be found by using triangulation methods as described above, or directly measured using the 3D camera sensor. Such a system can be used as a parking aid to determine the distance of the curb to the car. Similarly, it can be used on the highway to warn the driver if he is going too close to a car in front of the driver's car.

The invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for determining occupancy of a space, comprising:
defining a reference plane in the space using at least one optically generated fan light beam;
determining whether an object intersects the plane at an intersection, including interpreting an output of an optical imaging sensor placed in a known vertical position relative to the plane, and having a field of view that substantially coincides with the plane, wherein the object is in the field of view; and
calculating a shape of the intersection, a size of the intersection, and a relative location of the intersection in the space.

2. The method of claim 1, wherein the fan light beam has a spectrum in one of a group of spectra comprising visible spectra and invisible spectra.

3. The method of claim 1, wherein defining the reference plane includes using a rotating light source selected form a group comprising a laser and a light emitting diode.

4. The method of claim 1, wherein the optically generated fan light beam includes a scanning light beam.

5. The method of claim 1, the optically generated fan light beam includes multiple light sources selected from a group comprising lasers and light emitting diodes.

6. The method of claim 1, wherein the reference plane is generated by a light source selected from a group comprising lasers and light emitting diodes.

7. The method of claim 1, wherein the reference plane is selected form a group comprising the ground, the floor of a building, the floor of a room, and the floor of a compartment.

8. The method of claims 1, wherein the imaging sensor is selected from a group comprising a digital camera with a field of view, and a light sensitivity images the intersection pattern.

9. The method of claims 1, wherein a vertical distance of the imaging sensor from the reference plane is determined considering the size of the smallest object that must be detected by the sensor.

10. The method of claim 1, wherein determining includes:
taking a reference training image of the intersection;
taking another image of the space;
processing differences between the training image and the other image, including differences in intersection patterns in respective images;
if it is determined that an object intersects the plane at an intersection, estimating a size of the object and estimating a location of the object.

11. A method for detecting the presence of objects in a region of interest, comprising:
using a single-sensor 3D camera device with a field of view that substantially coincides with the region of the interest for detecting occupancy;
using image processing algorithms to detect objects closest to the 3D camera device;
using image processing algorithms to calculate a volume in front of the closest objects and a volume behind the closest objects.

12. The method of claims 11, wherein the 3D camera device uses a sensing technique chosen from a group comprising:
a time-of-flight method;
a depth-of-focus method;
a structured-light method; and
a triangulation method.

13. A system for detecting the presence of objects in a space, comprising:
at least one light source for generating an optical reference plane;
at least one camera device in a known vertical position relative to the reference plane and having a field of view that substantially coincides with the reference plane; and
an image processing system configured to process images produced by the camera for detecting the intersection of an object in the field of view intersects the reference plane.

14. A system for detecting an object in a space, comprising:
at least one sensor device that takes an image of the space, wherein an image comprises an instance of light recorded on a medium;
a means for defining a reference plane; and
means for determining whether the object intersects the plane at an intersection, wherein determining includes comparing different images of the space.

15. The system of claim 14, wherein the means for defining includes at least one of a physical surface and at least one light beam.

16. The system of claim 14, wherein the sensor device is selected from a group comprising a digital camera, and a 3D range sensor.

17. The system of claim 14, further comprising means for processing the different images of the space to determine whether the space is empty.

18. The system of claim 17, further comprising means for processing the different images of the space to calculate a full-ness factor for the space when the space is determined to be non-empty.

19. The system of claim 17, further comprising means for processing the different images of the space to calculate a full-ness factor for the space when the space is determined to be non-empty.

20. The system of claim 17, further comprising means for processing the different images of the space to calculate an object in the space when the space is determined to be non-empty.
